(19) United States
(12) Patent Application Publication
(10) Pub. No.: US 2026/0023193 A1
(43) Pub. Date: Jan. 22, 2026

(54) SIMULATIVE SOIL AND ROCK BOX BODY HAVING UNIVERSAL CONNECTION ASSEMBLY FOR FAULT FRACTURE ZONE

(71) Applicant: JIANGHAN UNIVERSITY, Wuhan (CN)

(72) Inventors: Longjun Xu, Weihai (CN); Jiaxin Han, Wuhan (CN); Jie Wang, Wuhan (CN); Xiangwen Feng, Wuhan (CN); Yuxuan Lu, Wuhan (CN)

(21) Appl. No.: 19/242,961

(22) Filed: Jun. 18, 2025

(30) Foreign Application Priority Data
Jul. 18, 2024 (CN) 202410962220.6

(51) Int. Cl. G01V 9/00; G01V 1/01

(52) U.S. Cl. CPC G01V 9/00; G01V 1/01

(57) ABSTRACT

Disclosed is a simulative soil and rock box body having a universal connection assembly for a fault fracture zone. The box body includes an end face opening, and a first box body and a second box body which are placed opposite the opening, where a fracture zone formation space which is formed in a spaced manner is arranged between the first box body and the second box body, the universal connection assembly is arranged at the fracture zone formation space, and the first box body and the second box body are connected through the universal connection assembly. According to the present disclosure, telescopic rods are arranged at the joint between support assemblies at the first box body and the second box body, and universal joints at end portions of the telescopic rods ensure that the telescopic rods can move in a wider range of angles.

### CROSS-REFERENCE TO RELATED APPLICATION

This application claims priority of Chinese Patent Application No. 202410962220.6, filed on Jul. 18, 2024, the entire contents of which are incorporated herein by reference.

### TECHNICAL FIELD

The present disclosure relates to the field of devices for simulating active faults of fracture zones, and in particular to a simulative soil and rock box body having a universal connection assembly for a fault fracture zone.

### BACKGROUND

It is an urgent task to simulate and reproduce a deformation dislocation process of a soil and rock stratum of a fracture zone more truly, so as to study the fracture deformation characteristics of the soil and rock stratum in the fault fracture zone during earthquake occurrence. Most of existing earthquake fault simulation test devices only use hydraulic cylinders to push two box bodies to simulate earthquake and fault dislocation, such that a fracture zone of test soil will be broken and deformed, thus simulating earthquake and fault movement. The test device only using the hydraulic cylinder to push two box bodies for simulation will be limited by the device itself, resulting in an insufficient width of an activity area of the fracture zone, and a driving effect of a driving device can not be fully exerted in a simulation process, resulting in insufficient activity intensity of the fracture zone area. Although an existing three-box-body test device can increase the width of the fracture zone to a certain extent, it will increase the cost of a test and is not flexible enough in practical operation. Earthquake fault simulation tests are performed to show more activity situations in more realistic fracture zones can help us better understand effects of earthquakes and faults. Therefore, a test device capable of truly simulating an external container of the fracture zone is a technical problem urgently needed to be solved in the field.

### SUMMARY

An objective of the present disclosure is to provide a simulative soil and rock box body having a universal connection assembly for a fault fracture zone, so as to solve the problems existing in the prior art.

An example of the present disclosure provides a simulative soil and rock box body having a universal connection assembly for a fault fracture zone. The box body includes an end face opening, and a first box body and a second box body which are placed opposite the opening, where a fracture zone formation space which is formed in a spaced manner is arranged between the first box body and the second box body, the universal connection assembly is arranged at the fracture zone forming space, and the first box body and the second box body are connected through the universal connection assembly.

The universal connection assembly includes two support assemblies, and the two support assemblies are mounted at openings of the first box body and the second box body. A flexible partition which semi-encloses the fracture zone formation space is connected between the two support assemblies, telescopic rods are arranged on an outer side of the flexible partition, and two ends of the telescopic rod are mounted on the support assemblies through universal joints. The flexible partition is double-layered, and a fluid space having an upper opening is formed between two layers. An inner lining of the flexible partition is of a rubber membrane, and the outer side of the flexible partition is provided with elastic belts in a crossed manner to limit an outer surface of the flexible partition.

A T-shaped groove is fixedly connected to the side surface, opposite the telescopic rod, of the support assembly, one end of the universal joint is slidably connected in the T-shaped groove through a T-shaped seat, and the other end of the universal joint is rotationally connected to the telescopic rod through a universal sphere seat.

A universal sphere is rotationally connected in the universal sphere seat, and the universal sphere is fixedly connected to the telescopic rod.

The support assembly includes an outer plate supporting the first box body or the second box body, a window is opened in a middle of the outer plate to allow the first box body or the second box body to pass therethrough, and the window makes the outer plate be in the shape of a right-angled U. Two vertical edges of the window are fixedly connected to crank plates, one end of the crank plate is connected to the outer plate to form a Z shape, and the other end of the crank plate extends to the fracture zone formation space. A tail end of the crank plate is overlapped with and fixedly connected to an opening end face of the first box body or the second box body.

A T-shaped groove is mounted on the outer plate, and the T-shaped groove extends along the shape of the outer plate to be in the shape of a right-angled U. A plurality of telescopic rods surround an outer side of the fracture zone formation space in a semi-enclosed manner through the T-shaped groove.

The telescopic rod includes an outer sleeve rod and an inner sliding rod, the inner sliding rod slides in the outer sleeve rod, and position limiting is arranged between the inner sliding rod and the outer sleeve rod.

The flexible partition is made of geotextile.

Test soil is placed in the first box body and the second box body, a test portion of the test soil is positioned in the fracture zone formation space, and fluid is poured into the fluid space to assist the test. Dislocation in a vertical direction occurs to the first box body through a seismic simulation shaking table, such that the telescopic rod moves vertically along with the universal joint mounted on the side of the first box body, and the inner sliding rod of the telescopic rod moves relative to the outer sleeve rod. Dislocation in a horizontal direction occurs to the second box body through the seismic simulation shaking table, such that the telescopic rod moves horizontally along with the universal joint mounted on the side of the second box body, and the telescopic rod does telescopic movement through relative movement between the inner sliding rod and the outer sleeve rod. Movement in multi-angle directions is capable of being performed between the first box body and the second box body through the telescopic rod and the universal joint, such that more fracture traces which are more complex occur to the test soil in the fracture zone formation space, so as to more realistically simulate a real earthquake occurrence situation.

The present disclosure has the beneficial effects as follows: according to the present disclosure, the telescopic rods are arranged at the joint between the support assemblies at the first box body and the second box body, the universal joints at end portions of the telescopic rods ensure that the telescopic rods can move in a wider range of angles, and the flexible change requirement of a test device for simulating an earthquake fault activity space is satisfied. The relative movement between the outer sleeve rod and the inner sliding rod in the telescopic rod ensures extrusion variability of the test soil in the fault activity. Arrangement of the universal joints achieves the possibility of multi-direction dislocation in the fault activity process. Compared with an existing device, the present disclosure is more in line with the state of an actual fault activity. Arrangement of the T-shaped grooves makes mounting of the telescopic rods is more convenient, the number of the telescopic rods can be flexibly configured, and an interval between the telescopic rods can be adjusted. The support assemblies are arranged at peripheries of the horizontal openings of the first box body and the second box body, are fixed at the horizontal openings of the first box body and the second box body through bolts, and are effectively connected to the universal joints and the telescopic rods, which obviously enlarges the fracture zone area of the test soil compared with the existing device, can more accurately and intuitively observe the process of the earthquake fault activity, and can reproduce space-time migration characteristics during faulting through a test. The support assembly is easy to operate and can be disassembled and assembled repeatedly. According to the present disclosure, the flexible partition made of the geotextile is employed in the main active area of the test and fixed on the support assembly through a bolt device to form a flexible connection enclosure, and flexibly changes in the active process of the telescopic rods, such that the leakage problem of the test soil in the fault activity process is effectively solved. The present disclosure employs the rubber membrane, the rubber membrane is lined in the geotextile and cooperates with the geotextile to form the fluid space with only the upper opening, and the fluid space can accommodate fluid of different materials to assist the test. According to the present disclosure, the rubber elastic belts are employed and arranged outside the geotextile in a crossed manner and fixed on the support assembly through the bolt device, and do not make contact with the telescopic rods, such that the problem that the geotextile may influence movement of the telescopic rods is effectively solved. Therefore, the present disclosure provides an active fault box device considering the fracture zone, and realizes effective simulation of the fault fracture zone.

### BRIEF DESCRIPTION OF THE DRAWINGS

FIG. 1 is a schematic diagram of an integral structure of the present disclosure.

FIG. 2 is a schematic diagram of a bottom structure of the present disclosure.

FIG. 3 is a schematic structural diagram of a support assembly.

FIG. 4 is a schematic structural diagram of a flexible partition.

FIG. 5 is a schematic structural diagram of a telescopic rod.

FIG. 6 is a schematic structural diagram of a universal joint.

In the figures:
1. first box body; 2. second box body; 3. fracture zone formation space; 4. support assembly; 5. outer plate; 6. window; 7. crank plate; 8. flexible partition; 9. rubber membrane; 10. elastic belt; 11. telescopic rod; 12. outer sleeve rod; 13. inner sliding rod; 14. universal joint; 15. T-shaped groove; 16. T-shaped seat; 17. universal sphere seat; and 18. universal sphere.

### DETAILED DESCRIPTIONS OF THE EMBODIMENTS

The technical solutions in the examples of the present disclosure will be clearly and completely described below with reference to the accompanying drawings in the examples of the present disclosure. Obviously, the described examples are merely some examples rather than all examples of the present disclosure. All the other examples obtained by those of ordinary skill in the art based on the examples in the present disclosure without creative efforts shall fall within the scope of protection of the present disclosure.

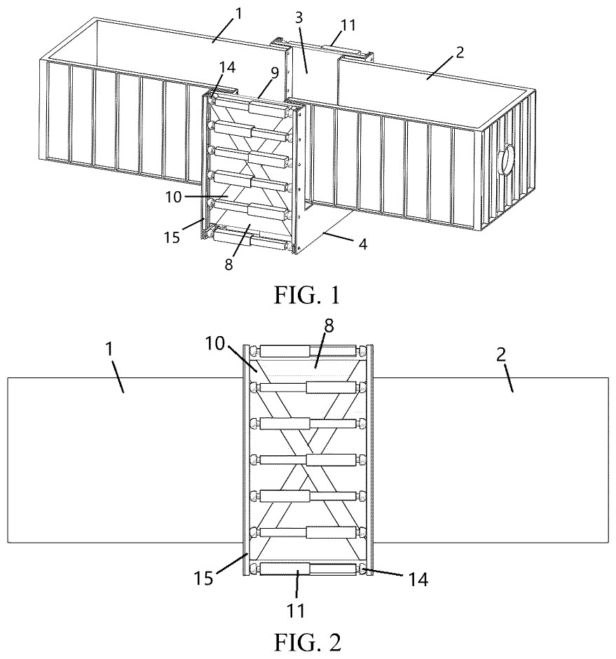

As shown in FIG. 1, a simulative soil and rock box body having a universal connection assembly for a fault fracture zone includes an end face opening, and a first box body 1 and a second box body 2 which are placed opposite the opening, where a fracture zone formation space 3 which is formed in a spaced manner is arranged between the first box body 1 and the second box body 2, the universal connection assembly is arranged at the fracture zone formation space 3, and the first box body 1 and the second box body 2 are connected through the universal connection assembly. Multi-angle free dislocation can be generated between the first box body 1 and the second box body 2 through the universal connection assembly, such that more complex and real fracture zone traces are formed in the fracture zone formation space 3.

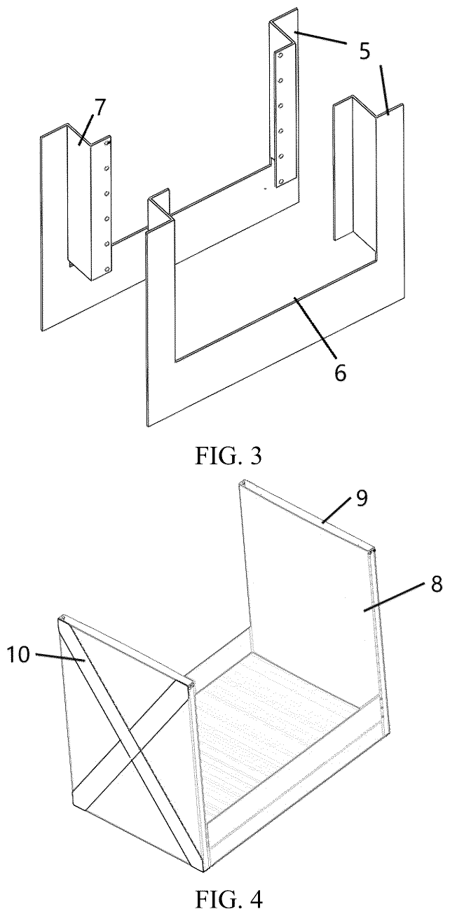

Specifically, the universal connection assembly includes two support assemblies 4, and the two support assemblies 4 are mounted at openings of the first box body 1 and the second box body 2. As shown in FIG. 3, the support assembly 4 includes an outer plate 5 supporting the first box body 1 or the second box body 2, a window 6 is opened in a middle of the outer plate 5 to allow the first box body 1 or the second box body 2 to pass therethrough, and the window 6 makes the outer plate 5 be in the shape of a right-angled U. Two vertical edges of the window 6 are fixedly connected to crank plates 7, one end of the crank plate 7 is connected to the outer plate 5 to form a Z shape, and the other end of the crank plate 7 extends to the fracture zone formation space 3. A tail end of the crank plate 7 is overlapped with and fixedly connected to an opening end face of the first box body 1 or the second box body 2 through bolts.

A flexible partition 8 which semi-encloses the fracture zone formation space 3 is connected between the two support assemblies 4. As shown in FIG. 4, the flexible partition 8 is preferably made of geotextile. The flexible partition 8 is double-layered, and a space for placing test soil is formed by inner-layer geotextile, the first box body 1, and the second box body 2. A fluid space having an upper opening is formed between the double layers of geotextile. An inner lining of the flexible partition 8 is of a rubber membrane 9, and the outer side of the flexible partition 8 is provided with elastic belts 10 in a crossed manner to limit an outer surface of the flexible partition 8, such that the situation that clod fall occurs to the test soil, and consequently, the flexible partition 8 expands outwards to affect movement of a telescopic rod 11 is prevented, and the elastic belts 10 prevent the flexible partition 8 from seriously deforming, thereby avoiding the flexible partition 8 from making contact with the telescopic rod 11. The elastic belts 10 are mounted to the outer plate 5 through bolts. The flexible partition 8 can provide flexibility during the relative movement of the two box bodies and prevent leakage of the test soil during the fault activity process.

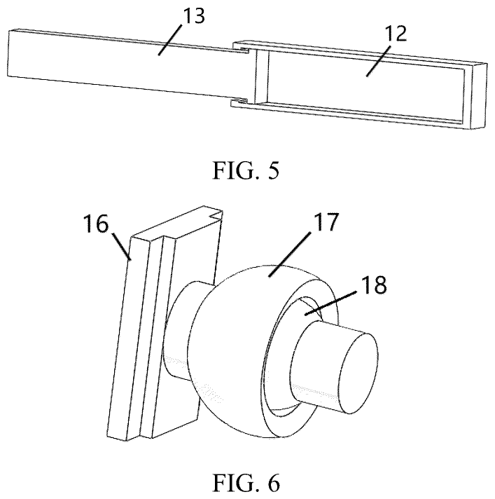

The telescopic rods 11 are arranged outside the flexible partition 8, and each telescopic rod 11 includes an outer sleeve rod 12 and an inner sliding rod 13, as shown in FIG. 5. The outer sleeve rod 12 is hollow, and the inner sliding rod 13 is solid. The inner sliding rod 13 slides in the outer sleeve rod 12, and position limiting is arranged between the inner sliding rod 13 and the outer sleeve rod 12. A thickness of the portion, close to a rod opening of the inner sliding rod 13, of the outer sleeve rod 12 is slightly greater than that of other portions of the outer sleeve rod 12, and a thickness of the portion, close to a rod opening of the outer sleeve rod 12, of the inner sliding rod 13 is slightly greater than that of other portions of the inner sliding rod 13.

Two ends of the telescopic rod 11 are mounted on the outer plate 5 of the support assembly 4 through universal joints 14. A T-shaped groove 15 is fixedly connected to the side surface, opposite the telescopic rod 11, of the outer plate 5, and the T-shaped groove 15 extends along the shape of the outer plate 5 to be in the shape of a right-angled U. A plurality of telescopic rods 11 surround an outer side of the fracture zone formation space 3 in a semi-enclosed manner through the T-shaped groove 15. Intervals exist the plurality of telescopic rods 11, and two adjacent telescopic rods 11 are mounted in opposite directions as shown in FIG. 2.

As shown in FIG. 6, one end of the universal joint 14 is slidably connected in the T-shaped groove 15 through a T-shaped seat 16, and the other end of the universal joint 14 is rotationally connected to the telescopic rod 11 through a universal sphere seat 17. A universal sphere 18 is rotationally connected in the universal sphere seat 17, the universal sphere 18 is attached to an inner surface of the universal sphere seat 17 to move around the center of the sphere, and the universal sphere 18 is fixedly connected to the telescopic rod 11, such that the telescopic rod 11 is driven to do multi-angle movement. More than ½ of the universal sphere 18 is wrapped in the universal sphere seat 17, so as to prevent the universal sphere 18 from separating from the universal sphere seat 17. The T-shaped seat 16 is fixed at an opposite position in the T-shaped groove 15 through bolts.

The universal joint 14 ensures that the telescopic rod 11 can move in a wider range of angles, such that the intensity of the simulated seismic activity of the present disclosure is obviously improved. The relative movement between the outer sleeve rod 12 and the inner sliding rod 13 in the telescopic rod 11 ensures the variability of the test soil during a fault activity, such that the width of the fracture zone generated by fault dislocation based on a seismic activity is obviously increased, and compared with an existing device, the present disclosure is more in line with the state of a realistic seismic activity. The T-shaped groove 15 makes the telescopic rods 11 easier to be mounted, the number of telescopic rods 11 is flexibly controlled, and spacing and positions of the telescopic rods 11 are easy to adjust.

During a test, the telescopic rods 11 and the universal joints 14 are fixed on the T-shaped groove 15 according to the number and interval required by the test, and the geotextile, the rubber membrane 9 and the elastic belt 10 are mounted in the fracture zone formation space 3. Fluid is poured into the fluid space according to the needs, and the elastic belts 10 with different strengths and different numbers may be employed according to the specific conditions of the test. Test soil is placed in the first box body 1 and the second box body 2, and a test portion of the test soil is positioned in the fracture zone formation space 3. Fluid is poured into the fluid space to assist the test, and fluid made of different materials may be poured into the fluid space to assist the test. Dislocation in a vertical direction occurs to the first box body 1 through a seismic simulation shaking table, such that the telescopic rod 11 moves vertically along with the universal joint 14 mounted on the side of the first box body 1, and the inner sliding rod 13 of the telescopic rod 11 moves relative to the outer sleeve rod 12. Dislocation in a horizontal direction occurs to the second box body 2 through the seismic simulation shaking table, such that the telescopic rod 11 moves horizontally along with the universal joint 14 mounted on the side of the second box body 2, and the telescopic rod 11 does telescopic movement through relative movement between the inner sliding rod 13 and the outer sleeve rod 12. Movement in multi-angle directions are capable of being performed between the first box body 1 and the second box body 2 through the telescopic rod 11 and the universal joint 14, such that more fracture traces which are more complex occur to the test soil in the fracture zone formation space 3, so as to more realistically simulate a real earthquake occurrence situation.

For those skilled in the art, it is apparent that the present disclosure is not limited to the details of the above-mentioned exemplary examples, and the present disclosure may be implemented in other specific forms without departing from the spirit or basic features of the present disclosure.

1. A simulative soil and rock box body having a universal connection assembly for a fault fracture zone, comprising an end face opening, and a first box body and a second box body which are placed opposite the opening, wherein a fracture zone formation space which is formed in a spaced manner is arranged between the first box body and the second box body, the universal connection assembly is arranged at the fracture zone formation space, and the first box body and the second box body are connected through the universal connection assembly; and
the universal connection assembly comprises two support assemblies, and the two support assemblies are mounted at openings of the first box body and the second box body; a flexible partition which semi-encloses the fracture zone formation space is connected between the two support assemblies, telescopic rods are arranged on an outer side of the flexible partition, and two ends of the telescopic rod are mounted on the support assemblies through universal joints; the flexible partition is double-layered, and a fluid space having an upper opening is formed between two layers; and an inner lining of the flexible partition is of a rubber membrane, and the outer side of the flexible partition is provided with elastic belts in a crossed manner to limit an outer surface of the flexible partition.

2. The simulative soil and rock box body having a universal connection assembly for a fault fracture zone according to claim 1, wherein a T-shaped groove is fixedly connected to the side surface, opposite the telescopic rod, of the support assembly, one end of the universal joint is slidably connected in the T-shaped groove through a T-shaped seat, and the other end of the universal joint is rotationally connected to the telescopic rod through a universal sphere seat.

3. The simulative soil and rock box body having a universal connection assembly for a fault fracture zone according to claim 2, wherein a universal sphere is rotationally connected in the universal sphere seat, and the universal sphere is fixedly connected to the telescopic rod.

4. The simulative soil and rock box body having a universal connection assembly for a fault fracture zone according to claim 1, wherein the support assembly comprises an outer plate supporting the first box body or the second box body, a window is opened in a middle of the outer plate to allow the first box body or the second box body to pass therethrough, and the window makes the outer plate be in the shape of a right-angled U; and two vertical edges of the window are fixedly connected to crank plates, one end of the crank plate is connected to the outer plate to form a Z shape, the other end of the crank plate extends to the fracture zone formation space, and a tail end of the crank plate is overlapped with and fixedly connected to an opening end face of the first box body or the second box body.

5. The simulative soil and rock box body having a universal connection assembly for a fault fracture zone according to claim 4, wherein a T-shaped groove is mounted on the outer plate, and the T-shaped groove extends along the shape of the outer plate to be in the shape of a right-angled U; and a plurality of telescopic rods surround an outer side of the fracture zone formation space in a semi-enclosed manner through the T-shaped groove.

6. The simulative soil and rock box body having a universal connection assembly for a fault fracture zone according to claim 1, wherein the telescopic rod comprises an outer sleeve rod and an inner sliding rod, the inner sliding rod slides in the outer sleeve rod, and position limiting is arranged between the inner sliding rod and the outer sleeve rod.

7. The simulative soil and rock box body having a universal connection assembly for a fault fracture zone according to claim 1, wherein the flexible partition is made of geotextile.

8. The simulative soil and rock box body having a universal connection assembly for a fault fracture zone according to claim 1, wherein test soil is placed in the first box body and the second box body, a test portion of the test soil is positioned in the fracture zone formation space, and fluid is poured into the fluid space to assist the test; dislocation in a vertical direction occurs to the first box body through a seismic simulation shaking table, to cause the telescopic rod to move vertically along with the universal joint mounted on the side of the first box body, and the inner sliding rod of the telescopic rod moves relative to the outer sleeve rod; dislocation in a horizontal direction occurs to the second box body through the seismic simulation shaking table, to cause the telescopic rod to move horizontally along with the universal joint mounted on the side of the second box body, and the telescopic rod does telescopic movement through relative movement between the inner sliding rod and the outer sleeve rod; and movement in multi-angle directions are capable of being performed between the first box body and the second box body through the telescopic rod and the universal joint, to cause more fracture traces which are more complex to occur to the test soil in the fracture zone formation space, so as to more realistically simulate a real earthquake occurrence situation.
